(19) United States
(12) Patent Application Publication
(10) Pub. No.: US 2016/0320884 A1
(43) Pub. Date: Nov. 3, 2016

(54) DEFLECTION-BASED AND/OR PROXIMITY-BASED SWITCHING OF COMPONENT STATE

(71) Applicant: Microsoft Technology Licensing, LLC, Redmond, WA (US)

(72) Inventors: David John Huston, Seattle, WA (US); Brian T. Whitman, University Place, WA (US); James Michael Bonicatto, Seattle, WA (US)

(21) Appl. No.: 14/698,452

(22) Filed: Apr. 28, 2015

(51) Int. Cl. G06F 3/041

(52) U.S. Cl. CPC G06F 3/0412

(57) ABSTRACT

Techniques are described herein that are capable of performing deflection-based and/or proximity-based switching of a component state. For instance, a computing device may include a display and a component. The component may be switched from an “on” state to an “off” state in response to a deflection of the display toward another portion (e.g., the component) of the computing device by at least a designated amount, in response to deflection of another portion of the computing device toward the display by at least a designated amount, in response to an object being within a designated proximity of the display or a portion thereof, in response to the object coming toward (e.g., approaching or being pressed against) the display with at least a designated intensity, etc.

### BACKGROUND

Computing devices (e.g., tablet computers, personal digital assistants) often include touch screens that enable the computing devices to detect touch commands and/or hover commands. For instance, a touch screen may include any of a variety of materials that are responsive to resistance, capacitance, and/or light for enabling detection of such commands. A touch screen usually includes a sensor matrix, which includes an array of row sensors and an array of column sensors. Each of the sensors in the arrays is typically configured to detect an object when the object is placed within a certain proximity to the sensor. For instance, an amount of resistance, capacitance, and/or light detected by the sensor may indicate whether the object is proximate the sensor. A location of the object with respect to the touch screen may be determined based on the amount(s) of resistance, capacitance, and/or light that are detected by one or more of the sensors.

As device manufacturers produce increasingly thinner computing devices, the structural rigidity of those computing devices is often reduced. For instance, stiffness of a cantilever beam scales with the cube of thickness in accordance with the equation I=(w*t̂3)/12, where I is the stiffness of the beam, w is the width of the beam, and t is the thickness of the beam. Accordingly, relatively small changes in thickness of a computing device can have a substantial effect on rigidity of the computing device.

When a user presses on a display of a relatively thin computing device, the display may be deflected into other parts of the computing device that reside behind the display. Contact of the display with the other parts of the computing device may damage the display and/or the other parts of the computing device or may negatively affect performance of the display and/or the other parts of the computing device.

### SUMMARY

Various approaches are described herein for, among other things, performing deflection-based and/or proximity-based switching of a component state. For instance, a computing device may include a display and a component. The component may be switched from an “on” state to an “off” state in response to a deflection of the display toward another portion (e.g., the component) of the computing device by at least a designated amount, in response to deflection of another portion of the computing device toward the display by at least a designated amount, in response to an object being within a designated proximity of the display or a portion thereof, in response to the object coming toward (e.g., approaching or being pressed against) the display with at least a designated intensity, etc.

Example computing devices are described. A first example computing device includes a display layer, a support structure, a deflection sensor, an electromechanical component, and a switching component. The support structure forms a void between the display layer and the support structure. The void is defined between a first surface of the display layer and a second surface of the support structure on opposing sides of the void. The deflection sensor is configured to determine an amount of deflection of the first surface toward the second surface in response to a pressure that is applied to a third surface of the display layer. The first surface and the third surface are on opposing sides of the display layer. The electromechanical component comprises a movable part that is configured to move in response to an activation signal being applied to the electromechanical component. The electromechanical component is configured to be in an “on” state or an “off” state. The “on” state is characterized by the activation signal being applied to the electromechanical component. The “off” state is characterized by the activation signal not being applied to the electromechanical component. The switching component is configured to switch the electromechanical component from the “on” state to the “off” state in response to the amount of the deflection reaching a deactivation threshold.

A second example computing device includes a display layer, a support structure, a deflection sensor, an electromechanical component, and a switching component. The support structure forms a void between the display layer and the support structure. The void is defined between a first surface of the display layer and a second surface of the support structure on opposing sides of the void. The deflection sensor is configured to determine an amount of deflection of the second surface toward the first surface in response to a pressure that is applied to a third surface of the support structure. The second surface and the third surface are on opposing sides of the support structure. The electromechanical component comprises a movable part that is configured to move in response to an activation signal being applied to the electromechanical component. The electromechanical component is configured to be in an “on” state or an “off” state. The “on” state is characterized by the activation signal being applied to the electromechanical component. The “off” state is characterized by the activation signal not being applied to the electromechanical component. The switching component is configured to switch the electromechanical component from the “on” state to the “off” state in response to the amount of the deflection reaching a deactivation threshold.

A third example computing device includes a display layer, a support structure, an electromechanical component, and a switching component. The display layer comprises a sensor matrix. The sensor matrix includes a plurality of sensors. The support structure is configured to form a void between the display layer and the support structure. The electromechanical component comprises a movable part that is configured to move in response to an activation signal being applied to the electromechanical component. The electromechanical component is configured to be in an “on” state or an “off” state. The “on” state is characterized by the activation signal being applied to the electromechanical component. The “off” state is characterized by the activation signal not being applied to the electromechanical component. The switching component is configured to switch the electromechanical component from the “on” state to the “off” state in response to detection of an object within a specified proximity of a designated portion of the sensor matrix. The designated portion includes a subset of the plurality of sensors. The subset corresponds to a location of the electromechanical component with respect to the display layer.

Example methods are also described. In a first example method, an electromechanical component of a computing device is caused to be in an “on” state. An amount of deflection of a first surface of a display layer of the computing device toward a second surface of a support structure of the computing device is determined in response to a pressure that is applied to a third surface of the display layer. The electromechanical component is switched from the “on” state to an “off” state in response to the amount of the deflection reaching a deactivation threshold.

In a second example method, an electromechanical component of a computing device is caused to be in an “on” state. An amount of deflection of a second surface of a support structure of the computing device toward a first surface of a display layer of the computing device is determined in response to a pressure that is applied to a third surface of the support structure. The electromechanical component is switched from the “on” state to an “off” state in response to the amount of the deflection reaching a deactivation threshold.

In a third example method, an electromechanical component of a computing device is caused to be in an “on” state. An object is detected within a specified proximity of a designated portion of a sensor matrix that is included in a display layer of the computing device. The sensor matrix includes sensors. The designated portion includes a subset of the sensors. The subset corresponds to a location of the mechanical component with respect to the display layer of the computing device. The electromechanical component is switched from the “on” state to an “off” state in response to detecting the object within the specified proximity of the designated portion of the sensor matrix.

Example computer program products are also described. A first example computer program product includes a computer-readable medium having computer program logic recorded thereon for enabling a processor-based system to perform deflection-based switching of a state of an electromechanical component of a computing device. The computer program logic includes first program logic, second program logic, and third program logic. The first program logic is for enabling the processor-based system to cause the electromechanical component to be in an “on” state. The second program logic is for enabling the processor-based system to determine an amount of deflection of a first surface of a display layer of the computing device toward a second surface of a support structure of the computing device in response to a pressure that is applied to a third surface of the display layer. The third program logic is for enabling the processor-based system to switch the electromechanical component from the “on” state to an “off” state in response to the amount of the deflection reaching a deactivation threshold.

A second example computer program product includes a computer-readable medium having computer program logic recorded thereon for enabling a processor-based system to perform deflection-based switching of a state of an electromechanical component of a computing device. The computer program logic includes first program logic, second program logic, and third program logic. The first program logic is for enabling the processor-based system to cause the electromechanical component to be in an “on” state. The second program logic is for enabling the processor-based system to determine an amount of deflection of a second surface of a support structure of the computing device toward a first surface of a display layer of the computing device in response to a pressure that is applied to a third surface of the support structure. The third program logic is for enabling the processor-based system to switch the electromechanical component from the “on” state to an “off” state in response to the amount of the deflection reaching a deactivation threshold.

A third example computer program product includes a computer-readable medium having computer program logic recorded thereon for enabling a processor-based system to perform proximity-based switching of a state of an electromechanical component of a computing device. The computer program logic includes first program logic, second program logic, and third program logic. The first program logic is for enabling the processor-based system to cause an electromechanical component of a computing device to be in an “on” state. The second program logic is for enabling the processor-based system to detect an object within a specified proximity of a designated portion of a sensor matrix that is included in a display layer of the computing device. The sensor matrix includes sensors. The designated portion includes a subset of the sensors. The subset corresponds to a location of the mechanical component with respect to the display layer of the computing device. The third program logic is for enabling the processor-based system to switch the electromechanical component from the “on” state to an “off” state in response to detecting the object within the specified proximity of the designated portion of the sensor matrix.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is perspective view of a computing device that is configured to perform deflection-based and/or proximity-based switching of a component state in accordance with an embodiment.

FIGS. 2-5 are side views of example computing devices that are configured to perform deflection-based switching of a component state in accordance with embodiments.

FIGS. 6-7 depict flowcharts of example methods for performing deflection-based switching of a component state in accordance with embodiments.

FIG. 8 is a block diagram of an example computing device that includes a sensor matrix in accordance with an embodiment.

FIG. 9 is an illustration of the example computing device of FIG. 8 in which an object is shown to be not within a specified proximity of a designated portion of the sensor matrix of the computing device in accordance with an embodiment.

FIG. 10 is an illustration of the example computing device of FIG. 8 in which an object is shown to be within a specified proximity of a designated portion of the sensor matrix of the computing device in accordance with an embodiment.

FIG. 11 depicts a flowchart of an example method for performing proximity-based switching of a component state in accordance with an embodiment.

FIG. 12 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Example Embodiments

Example embodiments described herein are capable of performing deflection-based and/or proximity-based switching of a component state. For instance, a computing device may include a display and a component. The component may be switched from an “on” state to an “off” state in response to a deflection of the display toward another portion (e.g., the component) of the computing device by at least a designated amount, in response to deflection of another portion of the computing device toward the display by at least a designated amount, in response to an object being within a designated proximity of the display or a portion thereof, in response to the object coming toward (e.g., approaching or being pressed against) the display with at least a designated intensity, etc. In some example embodiments, the component may be switched from the “off” state back to the “on” state in response to a deflection of the display toward another portion of the computing device (e.g., the component) being less than or equal to a specified amount, in response to deflection of another portion of the computing device toward the display being less than a specified amount, in response to an object no longer being within a designated proximity of the display or a portion thereof, in response to the object no longer coming toward (e.g., approaching or being pressed against) the display with at least a designated intensity, etc.

Example techniques described herein have a variety of benefits as compared to conventional techniques for controlling components in computing devices. For instance, the example techniques may preemptively turn off a component or part(s) thereof in a computing device before another portion (e.g., a display layer, a support structure) of the computing device comes into contact with the component. For instance, preemptively turning off the component or the part(s) thereof may stop movement of the part(s) prior to another portion of the computing device coming into contact with the component (e.g., the part(s)). Preemptively stopping the movement of the part(s) may prevent the movement of the part(s) from being stopped by a physical force associated with the contact.

Preemptively turning off the component or the part(s) thereof may (1) mitigate an amount of damage that occurs to the component and/or the other portion of the computing device as a result of the other portion coming into contact with the component; (2) prevent such damage from occurring; (3) mitigate an amount of noise that is generated as a result of the other portion coming into contact with the component; (4) prevent such noise from occurring; (5) prevent the component from stalling and/or drawing an increased (e.g., excessive) amount of current as a result of the other portion coming into contact with the component (e.g., as a result of the component being stopped by the physical force associated with the contact); and/or prevent an inaudible vibration.

The example techniques may cause a computing device to operate more efficiently. For instance, the example techniques may enable the computing device to consume fewer resources (e.g., current, power) when the other portion of the computing device is in contact with the component. The example techniques may increase reliability of the computing device. For instance, the example techniques may increase an operational lifetime of the component and/or the other portion of the computing device. The example techniques may decrease a likelihood that the component and/or the other portion of the computing device will be damaged as a result of the other portion coming into contact with the component. For instance, if the component is a fan that is stopping as a result of the contact, the example techniques may throttle down other element(s) of the computing device (e.g., before a temperature increase occurs).

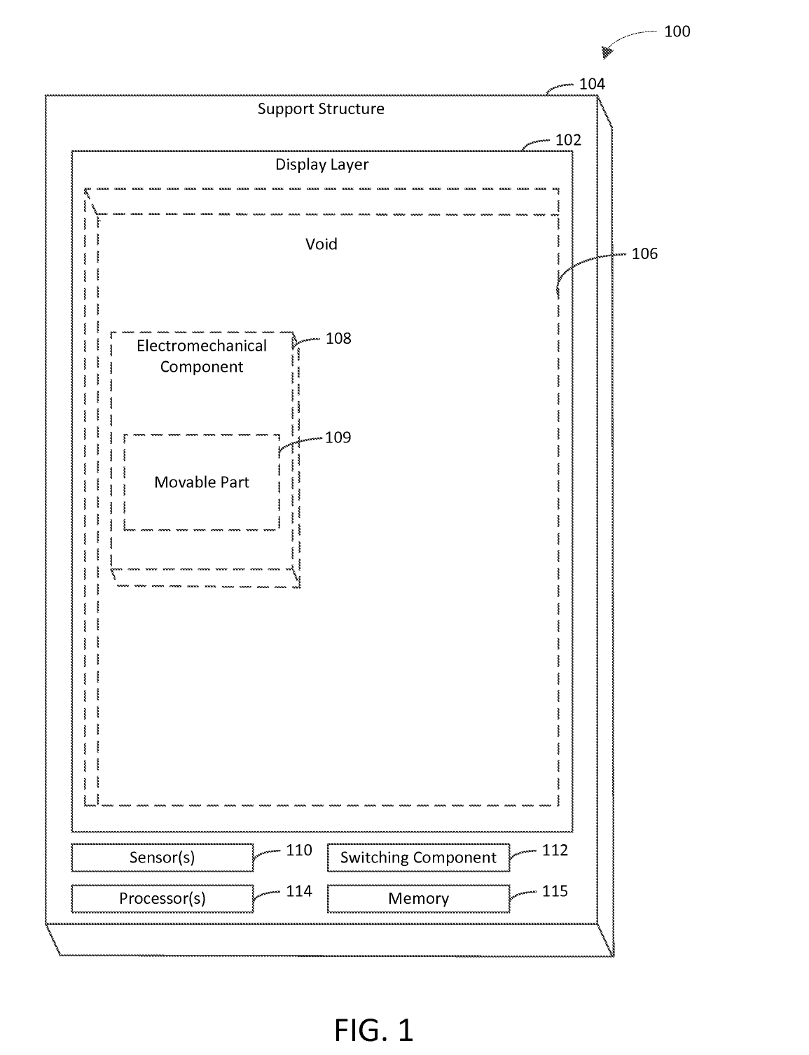

FIG. 1 is perspective view of a computing device 100 that is configured to perform deflection-based and/or proximity-based switching of a component state in accordance with an embodiment. The computing device 100 is a processing system that is capable of performing operations in response to input that is received from a user (e.g., via touch commands and/or hover commands). An example of a processing system is a system that includes at least one processor that is capable of manipulating data in accordance with a set of instructions. For instance, a processing system may be a computer (e.g., a tablet computer, a laptop computer, or a desktop computer), a personal digital assistant, a device with a touch display, etc.

The computing device 100 includes a display layer 102, a support structure 104, an electromechanical component 108, sensor(s) 110, a switching component 112, processor(s) 114, and a memory 115. The display layer 102 is configured to provide images for perception by a user. In an example embodiment, the display layer 102 is configured to be a touch screen. In accordance with this embodiment, touch and/or hover functionality of the display layer 102 is enabled by the sensor(s) 110, which are capable of sensing objects that are placed proximate the display layer 102. For instance, the sensor(s) 110 may be incorporated into the display layer 102. In one example, the sensor(s) 110 may sense a location at which an object physically touches the display layer 102. In accordance with this example, no space is between the object and the display layer 102. In another example, the sensor(s) 110 may sense a location at which an object hovers over the display layer 102. In accordance with this example, the object and the display layer 102 are spaced apart and do not touch. The sensor(s) 110 receive input from such objects via active or passive signals at locations on the display layer 102 that correspond to locations of the objects.

The support structure 104 is configured to provide structural support to the display layer 102. The support structure 104 forms a void 106 between the display layer 102 and the support structure 104. For instance, the support structure 104 may contact the display layer 102 along a perimeter of the void 106.

The electromechanical component 108 is configured to be in an “on” state or an “off” state. The “on” state is characterized by an activation signal being applied to the electromechanical component 108. The “off” state is characterized by the activation signal not being applied to the electromechanical component 108. The electromechanical component 108 includes a movable part 109. The movable part 109 is controlled by the activation signal. For instance, the movable part 109 moves when the activation signal is applied to the electromechanical component 108 (i.e., when the electromechanical component 108 is in the “on” state). Accordingly, the movable part 109 may stop moving when the activation signal is no longer applied to the electromechanical component 108 (i.e., when the electromechanical component 108 is in the “off” state).

In an example embodiment, the electromechanical component 108 is partially or entirely included in the void 106. In another example embodiment, the electromechanical component 108 is at least partially incorporated into the display layer 102 or the support structure 104. For instance, a surface of the electromechanical component 108 that is exposed to the void 106 may be in a common plane with a surface of the display layer 102 that is exposed to the void 106 or a surface of the support structure 104 that is exposed to the void 106. The electromechanical component 108 may be a motorized fan, though the scope of the example embodiments is not limited in this respect.

The sensor(s) 110 may include any suitable type of sensor, including but not limited to deflection sensor, touch sensor, specific absorption rate (SAR) capacitive sensor, or any combination thereof. A deflection sensor is a sensor that is configured to detect an amount of deflection of a portion of a computing device (e.g., the display layer 102 or the support structure 104 of the computing device 100). For instance, a deflection sensor may be a strain sensor. A strain sensor is a sensor that is configured to sense a strain that is imposed on a portion of a computing device (e.g., the display layer 102 or the support structure 104 of the computing device 100). A touch sensor is a sensor that is configured to detect an object that comes within a designated proximity of the touch sensor. An SAR capacitive sensor is configured to detect an object that comes within a designated proximity of the SAR capacitive sensor. It will be recognized that a deflection sensor may be configured as a touch sensor (e.g., with hover sensing functionality). It will be further recognized that a touch sensor may be configured to be a deflection sensor. The sensor(s) 110 may be attached to or incorporated in the display layer 102 and/or the support structure 104, though the scope of the example embodiments is not limited in this respect.

In some example embodiments, the sensor(s) 110 are configured to generate a signal (e.g., a time-varying signal) to be received by an object that is within a specified range of the sensor(s) 110. For example, the sensor(s) 110 may transmit the signal in anticipation of a response from an object that is within the specified range. In an aspect of this example, the signal that is transmitted by the sensor(s) 110 may be a time-varying voltage, and the response signal from the object may be a time-varying current that is generated based on a capacitance between the sensor(s) 110 and the object. In another aspect of this example, the signal that is transmitted by the sensor(s) 110 may be a first digital signal, and/or the response signal from the object may be a second digital signal that is generated based on the capacitance between the sensor(s) 110 and the object.

The switching component 112 (e.g., switching circuit or micro-switch) is configured to switch the electromechanical component 108 between on and “off” states based on signals that are provided by the sensor(s) 110. In a first example, the signals may indicate an amount of deflection of a portion (e.g., the display layer 102 or the support structure 104) of the computing device 100 and/or whether such deflection is less than, greater than, or equal to a deflection threshold (i.e., a deactivation threshold). In accordance with this example, the switching component 112 may be configured to switch the electromechanical component 108 from the “on” state to the “off” state in response to the deflection being greater than or equal to a first deflection threshold. In further accordance with this example, the switching component 112 may be configured to switch the electromechanical component 108 from the “off” state to the “on” state in response to the deflection being less than or equal to a second deflection threshold (i.e., a reactivation threshold). In an aspect of this example, the switching component 112 may be configured to switch the electromechanical component 108 from the “off” state to the “on” state in response to the deflection being less than or equal to the second deflection threshold for at least a designated period of time. (e.g., 5, 10, 20, 30, or 60 seconds). The first deflection threshold and the second deflection threshold may be the same value or different values. For instance, the second deflection threshold may be less than the first deflection threshold. If the electromechanical component 108 is a fan, the switching component 112 may drive throttling of a central processing unit (CPU), a graphical processing unit (GPU), and/or a system-on-chip (SoC).

In a second example, the signals may indicate whether an object is within a designated proximity of the display layer 102. In one aspect of the second example, the switching component 112 may be configured to switch the electromechanical component 108 from the “on” state to the “off” state in response to the object being within the designated proximity of the display layer 102. In accordance with this aspect, the switching component 112 may be configured to switch the electromechanical component 108 from the “off” state to the “on” state in response to the object no longer being within the designated proximity of the display layer 102. For instance, the switching component 112 may be configured to switch the electromechanical component 108 from the “off” state to the “on” state in response to the object not being within the designated proximity of the display layer 102 for at least a designated period of time. (e.g., 5, 10, 20, 30, or 60 seconds).

In another aspect of the second example, the switching component 112 may be configured to switch the electromechanical component 108 from the “on” state to the “off” state in response to the proximity of the object to the display layer 102 being less than or equal to a first proximity threshold (i.e., a deactivation threshold). In accordance with this aspect, the switching component 112 may be configured to switch the electromechanical component 108 from the “off” state to the “on” state in response to the proximity of the object to the display layer 102 being greater than or equal to a second proximity threshold (i.e., a reactivation threshold). For instance, the switching component 112 may be configured to switch the electromechanical component 108 from the “off” state to the “on” state in response to the proximity of the object to the display layer 102 being greater than or equal to the second proximity threshold for at least a designated period of time. (e.g., 5, 10, 20, 30, or 60 seconds). The first proximity threshold and the second proximity threshold may be the same value or different values. For instance, the second proximity threshold may be greater than the first proximity threshold.

In a third example, the signals may indicate an intensity with which the object is coming toward the display layer 102 and/or whether such intensity is less than, greater than, or equal to an intensity threshold. Examples of an intensity include but are not limited to force squared, momentum, velocity, and energy. For instance, the intensity may correspond to an amount of deflection of a portion of the computing device 100. In accordance with this example, the switching component 112 may be configured to switch the electromechanical component 108 from the “on” state to the “off” state in response to the intensity being greater than or equal to a first intensity threshold (i.e., a deactivation threshold). In further accordance with this example, the switching component 112 may be configured to switch the electromechanical component 108 from the “off” state to the “on” state in response to the intensity being less than or equal to a second intensity threshold (i.e., a reactivation threshold). In an aspect of this example, the switching component 112 may be configured to switch the electromechanical component 108 from the “off” state to the “on” state in response to the intensity being less than or equal to the second intensity threshold for at least a designated period of time. (e.g., 5, 10, 20, 30, or 60 seconds). The first intensity threshold and the second intensity threshold may be the same value or different values. For instance, the second intensity threshold may be less than the first intensity threshold.

In a fourth example, the signals may indicate a pressure intensity with which the object is pressed against the display layer 102 and/or whether such pressure intensity is less than, greater than, or equal to an intensity threshold. In accordance with this example, the switching component 112 may be configured to switch the electromechanical component 108 from the “on” state to the “off” state in response to the pressure intensity being greater than or equal to a first intensity threshold (i.e., a deactivation threshold). In further accordance with this example, the switching component 112 may be configured to switch the electromechanical component 108 from the “off” state to the “on” state in response to the pressure intensity being less than or equal to a second intensity threshold (i.e., a reactivation threshold). In an aspect of this example, the switching component 112 may be configured to switch the electromechanical component 108 from the “off” state to the “on” state in response to the pressure intensity being less than or equal to the second intensity threshold for at least a designated period of time. (e.g., 5, 10, 20, 30, or 60 seconds). The first intensity threshold and the second intensity threshold may be the same value or different values. For instance, the second intensity threshold may be less than the first intensity threshold.

In a fifth example, the signals may indicate a capacitance change associated with at least a portion of the display layer 102 and/or whether such capacitance change is less than, greater than, or equal to a capacitance change threshold. In accordance with this example, the switching component 112 may be configured to switch the electromechanical component 108 from the “on” state to the “off” state in response to the capacitance change being greater than or equal to a first capacitance change threshold (i.e., a deactivation threshold). In further accordance with this example, the switching component 112 may be configured to switch the electromechanical component 108 from the “off” state to the “on” state in response to the capacitance change being less than or equal to a second capacitance change threshold (i.e., a reactivation threshold). The first capacitance change threshold and the second capacitance change threshold may be the same value or different values. For instance, the first capacitance change threshold may be positive, and the second capacitance change threshold may be negative. A positive capacitance change may indicate that the distance between the object and the portion of the display layer 102 has decreased. A more positive capacitance change may correspond to a greater decrease of the distance. A negative capacitance change may indicate that the distance between the object and the portion of the display layer 102 has increased. A more negative capacitance change may correspond to a greater increase in the distance.

In a sixth example, the signals may indicate a capacitance associated with at least a portion of the display layer 102 and/or whether such capacitance is less than, greater than, or equal to a capacitance threshold. In accordance with this example, the switching component 112 may be configured to switch the electromechanical component 108 from the “on” state to the “off” state in response to the capacitance being greater than or equal to a first capacitance threshold (i.e., a deactivation threshold). In further accordance with this example, the switching component 112 may be configured to switch the electromechanical component 108 from the “off” state to the “on” state in response to the capacitance being less than or equal to a second capacitance threshold (i.e., a reactivation threshold). In an aspect of this example, the switching component 112 may be configured to switch the electromechanical component 108 from the “off” state to the “on” state in response to the capacitance being less than or equal to the second capacitance threshold for at least a designated period of time. (e.g., 5, 10, 20, 30, or 60 seconds). The first capacitance threshold and the second capacitance threshold may be the same value or different values. For instance, the second capacitance threshold may be less than the first capacitance threshold.

The deactivation thresholds and the reactivation thresholds described above with reference to the first through sixth examples, are not limited to those examples with regard to which the thresholds are described. For instance, the switching component 112 may be configured to switch the electromechanical component 108 from the “on” state to the “off” state based on a deactivation threshold described with respect to one example and may be further configured to switch the electromechanical component 108 from the “off” state to the “on” state based on a reactivation threshold described with respect to another example.

In accordance with any one or more of the first through sixth examples mentioned above, the switching component 112 may be configured to switch the electromechanical component 108 to the “off” state for a specified period of time. For instance, the specified period of time may be determined prior to a determination of the amount of the deflection mentioned in the first example, the proximity of the object to the display layer 102 as mentioned in the second example, the intensity with which the object comes toward the display layer 102 as mentioned in the third example, the pressure intensity mentioned in the fourth example, the capacitance change mentioned in the fifth example, and/or the capacitance mentioned in the sixth example.

Switching the electromechanical component 108 from the “on” state to the “off” state may preemptively stop movement of the movable part 109 prior to another portion (e.g., the display layer 102 or the support structure 104) of the computing device 100 coming into contact with the movable part 109. For instance, preemptively stopping the movement of the movable part 109 may prevent the movable part 109 from making noise, damaging the other portion of the computing device 100, and/or being damaged when the other portion of the computing device 100 comes into contact with the movable part 109. For example, preemptively stopping the movement of the movable part 109 may prevent the movement of the movable part 109 from being stopped by a physical force associated with the contact, which may prevent the movable part 109 from becoming electrically inoperable (e.g., burned out) as a result of being stopped by the physical force.

The processor(s) 114 are configured to perform operations based on instructions that are stored in the memory 115. Such operations may include processing signals that are received from the sensor(s) 110 and/or controlling the switching component 112 based on the signals that are received from the sensor(s) 110. For example, the processor(s) 114 may cause the switching component 112 to switch the electromechanical component 108 from the “on” state to the “off” state in response to receipt of one or more first signals from the sensor(s) 110. In another example, the processor(s) 114 may cause the switching component 112 to switch the electromechanical component 108 from the “off” state to the “on” state in response to receipt of one or more second signals from the sensor(s) 110. It will be recognized that at least a portion of the processor(s) 114 may be included in (e.g., incorporated into) the sensor(s) 110 and/or the switching component 112.

The memory 115 stores computer-readable instructions that are executable by the processor(s) 114 to perform operations. The memory 115 may include any suitable type of memory, including but not limited to read only memory (ROM), random access memory (RAM), flash memory, etc.

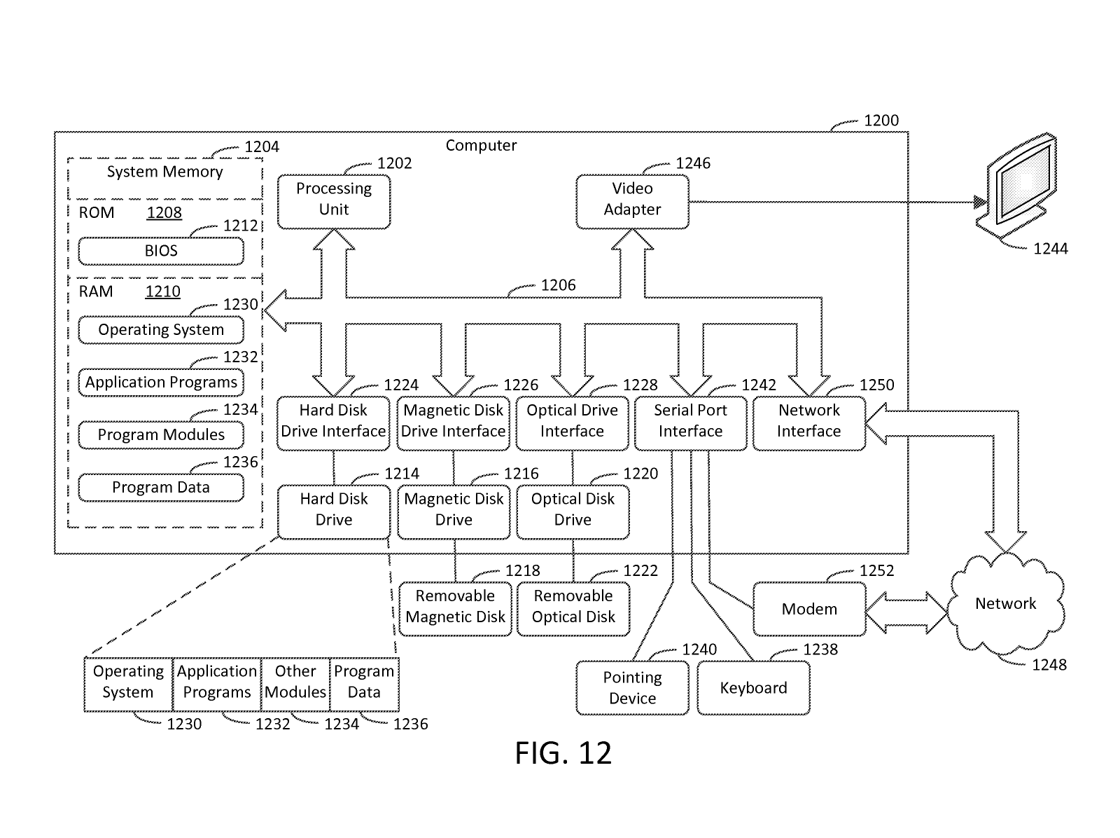

It will be recognized that the computing device 100 may not include one or more of the display layer 102, the support structure 104, the electromechanical component 108, the movable part 109, the sensor(s) 110, the switching component 112, the processor(s) 114, and/or the memory 115. Furthermore, the computing device 100 may include components in addition to or in lieu of the display layer 102, the support structure 104, the electromechanical component 108, the movable part 109, the sensor(s) 110, the switching component 112, the processor(s) 114, and/or the memory 115. For instance, the computing device 100 may include any one or more of the components shown in FIG. 12, which is discussed in further detail below.

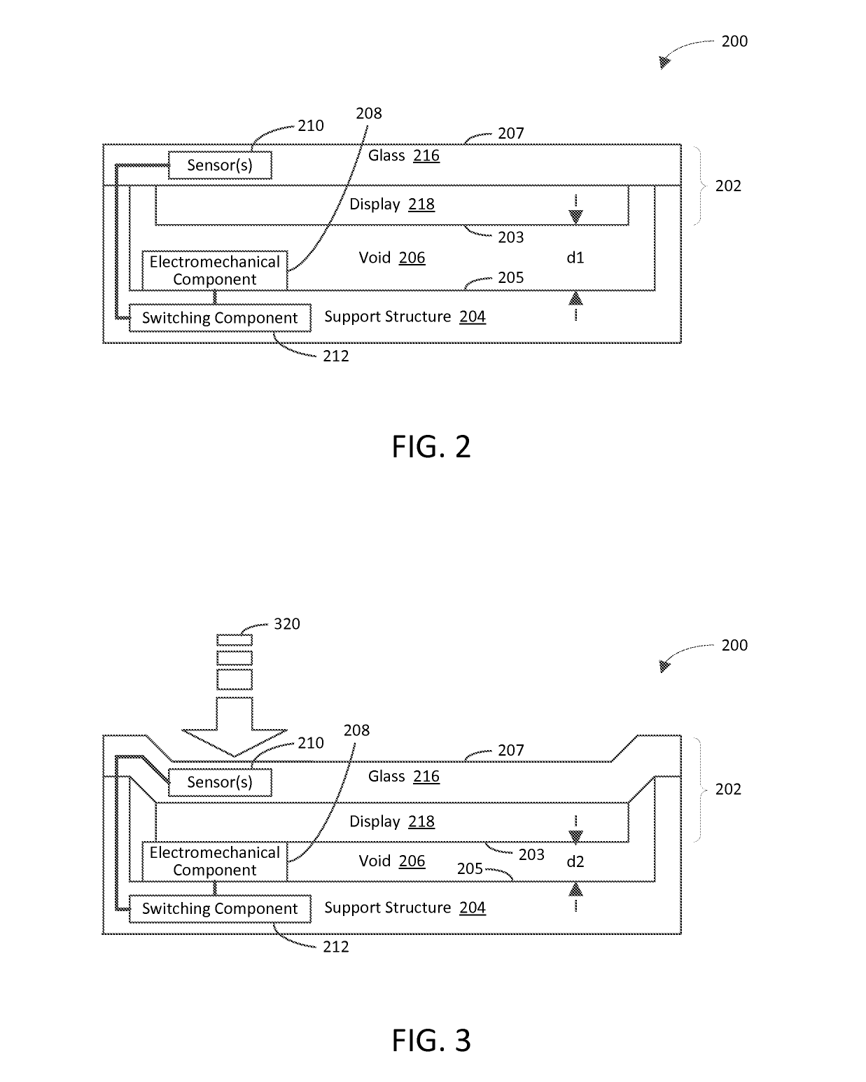

FIGS. 2-3 are side views of an example computing device 200 that is configured to perform deflection-based switching of a component state in accordance with an embodiment. As shown in FIG. 2, the computing device 200 includes a display layer 202, a support structure 204, an electromechanical component 208, sensor(s) 210, and a switching component 212, which are operable in a manner similar to the display layer 102, the support structure 104, the electromechanical component 108, the sensor(s) 110, and the switching component 112 shown in FIG. 1.

The support structure 204 forms a void 206 between the support structure 204 and the display layer 202. The void 206 is shown to be formed between a first surface 203 of the display layer 202 and a second surface 205 of the support structure 204.

The switching component 212 is electrically coupled to the sensor(s) 210 to enable the switching component 212 to receive signals from the sensor(s) 210. The switching component 212 is also electrically coupled to the electromechanical component 208 to enable the switching component 212 to control the electromechanical component 208, including part(s) therein, based on the signals that are received from the sensor(s) 210.

The display layer 202 is shown to include glass 216 and a display 218 for illustrative purposes and is not intended to be limiting. The display 218 includes a liquid crystal layer, a backlight, and other elements to facilitate providing images for perception by a user. For instance, the display 218 may be a liquid crystal module (LCM) or an organic light-emitting diode (OLED) module. The glass 216 is configured to protect the display 218 from environmental factors, such as a user interacting (e.g., pressing against) the display layer 202, while allowing images that are generated by the display 218 to be perceived by the user.

In FIG. 2, the display layer 202 is shown to be in a non-deflected state, meaning that the first surface 203 of the display layer 202 is not deflected toward the second surface 205 of the support structure 204 (e.g., as a result of a pressure being applied to a third surface 207 of the display layer 202). A distance between the first surface 203 and the second surface 205 when the display layer 202 is in the non-deflected state is represented as d1.

The sensor(s) 210 are shown to be coupled to the display layer 202 for illustrative purposes and is not intended to be limiting. For instance, the sensor(s) 210 may be at least partially included within the glass 216 (as shown in FIG. 2), at least partially included within the display 218, positioned between the glass 216 and the display 218, coupled to the first surface 203 of the display layer 202, coupled to the third surface 207 of the display layer 202, etc. It will be recognized that the sensor(s) 210 need not necessarily be coupled to the display layer 202. For instance, the sensor(s) 210 may be coupled to the support structure 404 (e.g., the second surface 205 of the support structure 404).

The electromechanical component 208 is shown to be coupled to the second surface 205 of the support structure 204 for illustrative purposes and is not intended to be limiting. For example, the electromechanical component 208 may be at least partially included within the support structure 204. In another example, the electromechanical component 208 may be coupled to the first surface 203 of the display layer 202 (e.g., rather than to the second surface 205 of the support structure 204). In another example, the electromechanical component 208 may be at least partially included within the display layer 202.

The switching component 212 is shown to be coupled to the support structure 204 for illustrative purposes and is not intended to be limiting. It will be recognized that the switching component 212 need not necessarily be coupled to the support structure 204. The switching component 212 may be at least partially (e.g., entirely) included within the support structure 204 (as shown in FIG. 2), at least partially included within the display layer 202, coupled to the first surface 203 of the display layer 202, coupled to the second surface 205 of the support structure 204, etc. It will be recognized that the switching component 212 may be incorporated into the sensor(s) 210. For instance, the switching component 212 may be a micro-switch.

Referring now to FIG. 3, the display layer 202 is shown to be in a deflected state, meaning that the first surface 203 of the display layer 202 is deflected toward the second surface 205 of the support structure 204 as a result of a pressure 320 being applied to the third surface 207 of the display layer 202. A distance between the first surface 203 and the second surface 205 when the display layer 202 is in the deflected state is represented as d2, which is less than d1. The display layer 202 is shown to be in contact with the electromechanical component 208 in FIG. 3 for non-limiting illustrative purposes. Persons skilled in the relevant art(s) will recognize that the display layer 202 need not necessarily be in contact with the electromechanical component 208 when the display layer 202 is in the deflected state.

The switching component 212 is configured to switch the electromechanical component 208 from the “on” state to the “off” state in response to a difference between d1 and d2 being greater than or equal to a deactivation threshold. In one example, the deactivation threshold may be equal to a designated percentage of d1 (i.e., a percentage of the distance between the first surface 203 of the display layer 202 and the second surface 205 of the support structure 204 in absence of the pressure 320 being applied to the third surface 207 of the display layer 202). For instance, the deactivation threshold may be equal to approximately 20%, 30%, 40%, 50%, 60%, 70%, or 80% of d1. In another example, the deactivation threshold may be a designated distance. For instance, the deactivation threshold may be equal to approximately 0.1 mm, 0.2 mm, 0.3 mm, or 0.5 mm.

In an example embodiment, the sensor(s) 210 include a strain sensor. In accordance with this embodiment, the strain sensor is configured to sense a strain that is imposed on the display layer 202 based on (e.g., as a result of) the pressure 320 being applied to the third surface 207 of the display layer 202. In further accordance with this embodiment, the sensor(s) 210 are configured to determine the amount of the deflection based on the strain. For instance, the deflection may be proportional (e.g., directly proportional) to the strain.

In an another example embodiment, the sensor(s) 210 are configured to determine the amount of the deflection of a portion of the first surface 203 that corresponds to a projection of the electromechanical component 208 onto the first surface 203 toward the second surface 205 in response to the pressure 320 being applied to the third surface 207 of the display layer 202. In accordance with this embodiment, the distance d1 corresponds to the distance between (a) the portion of the first surface 203 that corresponds to the projection of the electromechanical component 208 onto the first surface 203 and (b) the second surface 205 when the display layer 202 is in the non-deflected state. In further accordance with this embodiment, the distance d2 corresponds to the distance between (a) the portion of the first surface 203 that corresponds to the projection of the electromechanical component 208 onto the first surface 203 and (b) the second surface 205 when the display layer 202 is in the deflected state.

It will be recognized that the computing device 200 shown in FIGS. 2-3 may not include one or more of the display layer 202, the support structure 204, the electromechanical component 208, the sensor(s) 210, the switching component 212, the glass 216, and/or the display 218. Furthermore, the computing device 200 may include components in addition to or in lieu of the display layer 202, the support structure 204, the electromechanical component 208, the sensor(s) 210, the switching component 212, the glass 216, and/or the display 218.

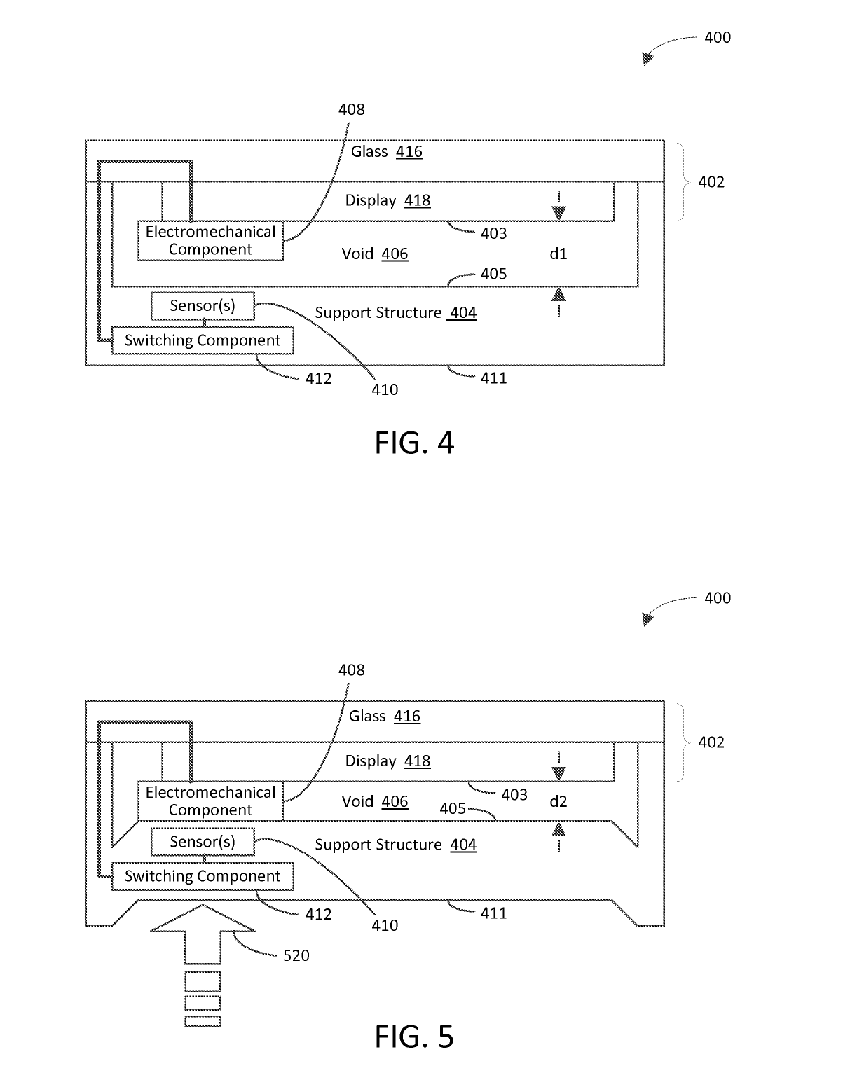

FIGS. 4-5 are side views of another example computing device 400 that is configured to perform deflection-based switching of a component state in accordance with an embodiment. As shown in FIG. 4, the computing device 400 includes a display layer 402, a support structure 404, an electromechanical component 408, sensor(s) 410, and a switching component 412, which are operable in a manner similar to the display layer 102, the support structure 104, the electromechanical component 108, the sensor(s) 110, and the switching component 112 shown in FIG. 1. The display layer 402 is shown to include glass 416 and a display 418, which are operable in a manner similar to the glass 216 and the display 218 shown in FIG. 3.

The support structure 404 forms a void 406 between the support structure 404 and the display layer 402. The void 406 is shown to be formed between a first surface 403 of the display layer 402 and a second surface 405 of the support structure 404.

The switching component 412 is electrically coupled to the sensor(s) 410 to enable the switching component 412 to receive signals from the sensor(s) 410. The switching component 412 is also electrically coupled to the electromechanical component 408 to enable the switching component 412 to control the electromechanical component 408, including part(s) therein, based on the signals that are received from the sensor(s) 410. It will be recognized that the switching component 412 may be incorporated into the sensor(s) 410. For instance, the switching component 412 may be a micro-switch.

In FIG. 4, the support structure 404 is shown to be in a non-deflected state, meaning that the second surface 405 of the support structure 404 is not deflected toward the first surface 403 of the display layer 402 (e.g., as a result of a pressure being applied to a third surface 411 of the support structure 404). A distance between the first surface 403 and the second surface 405 when the support structure 404 is in the non-deflected state is represented as d1.

The sensor(s) 410 are shown to be coupled to the support structure 404 for illustrative purposes and is not intended to be limiting. For instance, the sensor(s) 410 may be at least partially (e.g., entirely) included within the support structure 404 (as shown in FIG. 4), coupled to the second surface 405 of the support structure 404, coupled to the third surface 411 of the support structure 404, etc. It will be recognized that the sensor(s) 410 need not necessarily be coupled to the support structure 404. For instance, the sensor(s) 410 may be coupled to the display layer 402 (e.g., the first surface 403 of the display layer 402).

The electromechanical component 408 is shown to be coupled to the first surface 403 of the display layer 402 for illustrative purposes and is not intended to be limiting. For example, the electromechanical component 408 may be at least partially included within the display layer 402. In another example, the electromechanical component 408 may be coupled to the second surface 405 of the support structure 404 (e.g., rather than to the first surface 403 of the display layer 402). In another example, the electromechanical component 408 may be at least partially included within the support structure 404.

The switching component 412 is shown to be coupled to the support structure 404 for illustrative purposes and is not intended to be limiting. It will be recognized that the switching component 412 need not necessarily be coupled to the support structure 404. The switching component 412 may be at least partially (e.g., entirely) included within the support structure 404 (as shown in FIG. 4), at least partially included within the display layer 402, coupled to the first surface 403 of the display layer 402, coupled to the second surface 405 of the support structure 404, etc.

Referring now to FIG. 5, the support structure 404 is shown to be in a deflected state, meaning that the second surface 405 of the support structure 404 is deflected toward the first surface 403 of the display layer 402 as a result of a pressure 520 being applied to the third surface 411 of the support structure 404. A distance between the first surface 403 and the second surface 405 when the support structure 404 is in the deflected state is represented as d2, which is less than d1. The support structure 404 is shown to be in contact with the electromechanical component 408 in FIG. 5 for non-limiting illustrative purposes. Persons skilled in the relevant art(s) will recognize that the support structure 404 need not necessarily be in contact with the electromechanical component 408 when the support structure 404 is in the deflected state.

The switching component 412 is configured to switch the electromechanical component 408 from the “on” state to the “off” state in response to a difference between d1 and d2 being greater than or equal to a deactivation threshold. In one example, the deactivation threshold may be equal to a designated percentage of d1 (i.e., a percentage of the distance between the first surface 403 of the display layer 402 and the second surface 405 of the support structure 404 in absence of the pressure 520 being applied to the third surface 411 of the support structure 404). For instance, the deactivation threshold may be equal to approximately 20%, 30%, 40%, 50%, 60%, 70%, or 80% of d1. In another example, the deactivation threshold may be a designated distance. For instance, the deactivation threshold may be equal to approximately 0.1 mm, 0.2 mm, 0.3 mm, or 0.5 mm.

In an example embodiment, the sensor(s) 410 include a strain sensor. In accordance with this embodiment, the strain sensor is configured to sense a strain that is imposed on the support structure 404 based on (e.g., as a result of) the pressure 520 being applied to the third surface 411 of the support structure 404. In further accordance with this embodiment, the sensor(s) 410 are configured to determine the amount of the deflection based on the strain.

In an another example embodiment, the sensor(s) 410 are configured to determine the amount of the deflection of a portion of the second surface 405 that corresponds to a projection of the electromechanical component 408 onto the second surface 405 toward the first surface 403 in response to the pressure 520 being applied to the third surface 411 of the support structure 404. In accordance with this embodiment, the distance d1 corresponds to the distance between (a) the portion of the second surface 405 that corresponds to the projection of the electromechanical component 408 onto the second surface 405 and (b) the first surface 403 when the support structure 404 is in the non-deflected state. In further accordance with this embodiment, the distance d2 corresponds to the distance between (a) the portion of the second surface 405 that corresponds to the projection of the electromechanical component 408 onto the second surface 405 and (b) the first surface 403 when the support structure 404 is in the deflected state.

It will be recognized that the computing device 400 shown in FIGS. 4-5 may not include one or more of the display layer 402, the support structure 404, the electromechanical component 408, the sensor(s) 410, the switching component 412, the glass 416, and/or the display 418. Furthermore, the computing device 400 may include components in addition to or in lieu of the display layer 402, the support structure 404, the electromechanical component 408, the sensor(s) 410, the switching component 412, the glass 416, and/or the display 418.

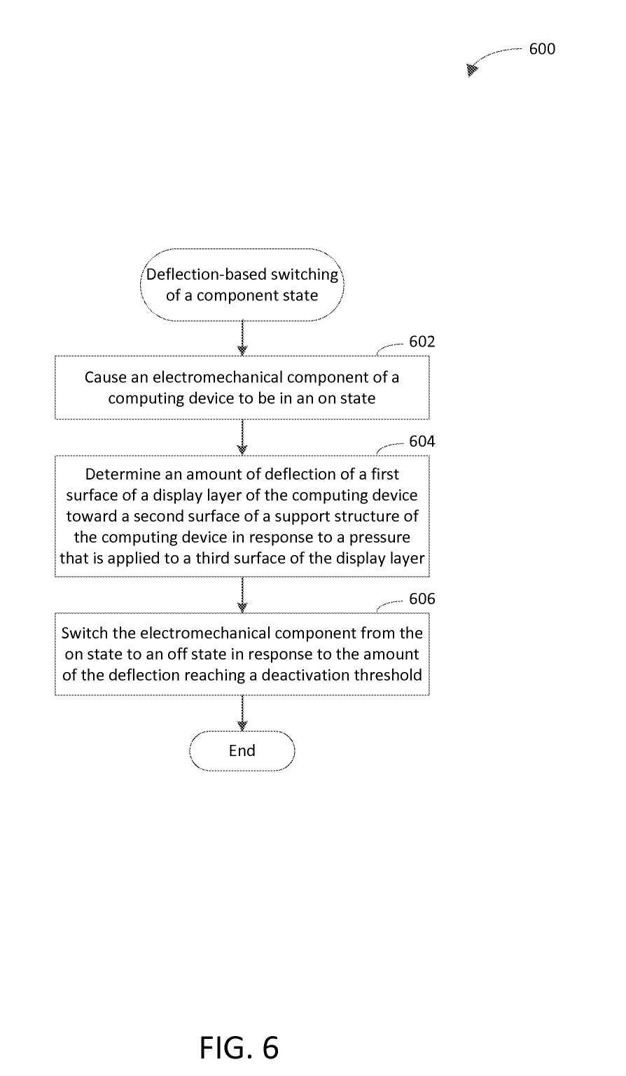

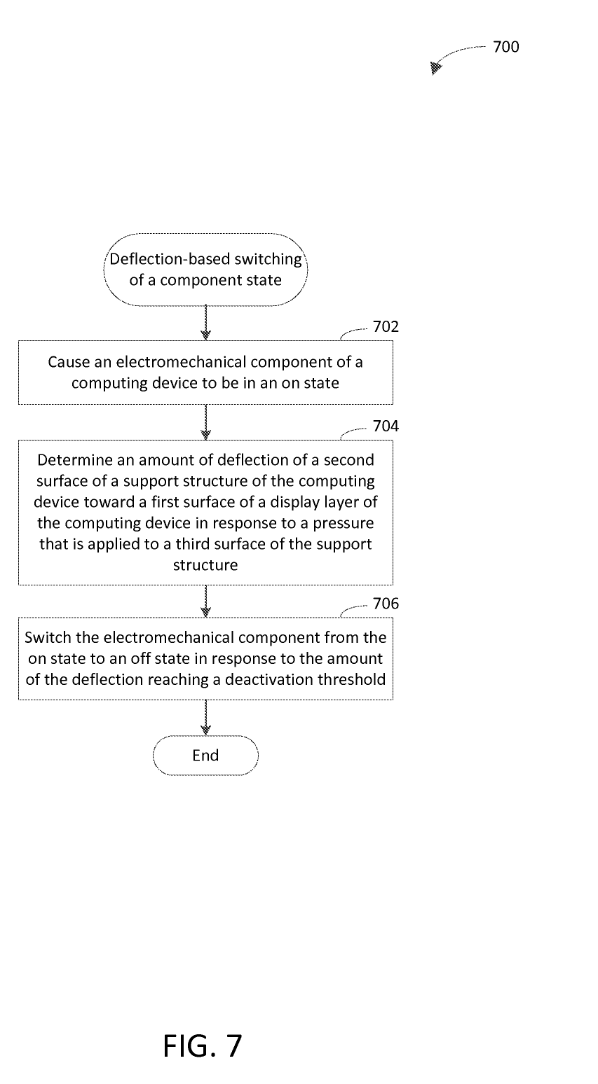

FIGS. 6-7 depict flowcharts 600, 700 of example methods for performing deflection-based switching of a component state in accordance with embodiments. The flowcharts 600, 700 may be performed by a computing device 100 shown in FIG. 1, a computing device 200 shown in FIGS. 2-3, or a computing device 400 shown in FIGS. 4-5, for example. For illustrative purposes, the flowchart 600 is described with respect to the computing device 200 shown in FIGS. 2-3. The flowchart 700 is described with respect to the computing device 400 shown in FIGS. 4-5. Further structural and operational embodiments will be apparent to persons skilled in the relevant art(s) based on the discussion regarding the flowcharts 600, 700.

As shown in FIG. 6, the method of the flowchart 600 begins at step 602. In step 602, an electromechanical component of a computing device is caused to be in an “on” state. For instance, step 602 may include applying an activation signal to the electromechanical component. Application of the activation signal may cause a moving part of the electromechanical component to move. In an example implementation, a switching component 212 of the computing device 200 causes an electromechanical component 208 to be in the “on” state.

At step 604, an amount of deflection of a first surface of a display layer of the computing device toward a second surface of a support structure of the computing device in response to a pressure that is applied to a third surface of the display layer is determined. For instance, the first surface and the third surface may be on opposing sides of the display layer. The first surface and the second surface may define a void between the display layer and the support structure. In an example implementation, sensor(s) 210 of the computing device 200 determine an amount of deflection of a first surface 203 of a display layer 202 of the computing device 200 toward a second surface 205 of a support structure 204 of the computing device 200 in response to a pressure 320 that is applied to a third surface 207 of the display layer 202.

At step 606, the electromechanical component is switched from the “on” state to an “off” state in response to the amount of the deflection reaching a deactivation threshold. For instance, step 606 may include discontinuing the application of the activation signal to the electromechanical component 208. In an example implementation, the switching component 212 switches the electromechanical component 208 from the “on” state to the “off” state in response to the amount of the deflection reaching the deactivation threshold.

In some example embodiments, one or more steps 602, 604, and/or 606 of flowchart 600 may not be performed. Moreover, steps in addition to or in lieu of steps 602, 604, and/or 606 may be performed.

As shown in FIG. 7, the method of the flowchart 700 begins at step 702. In step 702, an electromechanical component of a computing device is caused to be in an “on” state. For instance, step 702 may include applying an activation signal to the electromechanical component. Application of the activation signal may cause a moving part of the electromechanical component to move. In an example implementation, a switching component 412 of the computing device 400 causes an electromechanical component 408 to be in the “on” state.

At step 704, an amount of deflection of a second surface of a support structure of the computing device toward a first surface of a display layer of the computing device in response to a pressure that is applied to a third surface of the support structure is determined. For instance, the second surface and the third surface may be on opposing sides of the support structure. The first surface and the second surface may define a void between the display layer and the support structure. In an example implementation, sensor(s) 410 of the computing device 400 determine an amount of deflection of a second surface 405 of a support structure 404 of the computing device 400 toward a first surface 403 of a display layer 402 of the computing device 400 in response to a pressure 420 that is applied to a third surface 411 of the support structure 404.

At step 706, the electromechanical component is switched from the “on” state to an “off” state in response to the amount of the deflection reaching a deactivation threshold. For instance, step 706 may include discontinuing the application of the activation signal to the electromechanical component 408. In an example implementation, the switching component 412 switches the electromechanical component 408 from the “on” state to the “off” state in response to the amount of the deflection reaching the deactivation threshold.

In some example embodiments, one or more steps 702, 704, and/or 706 of flowchart 700 may not be performed. Moreover, steps in addition to or in lieu of steps 702, 704, and/or 706 may be performed.

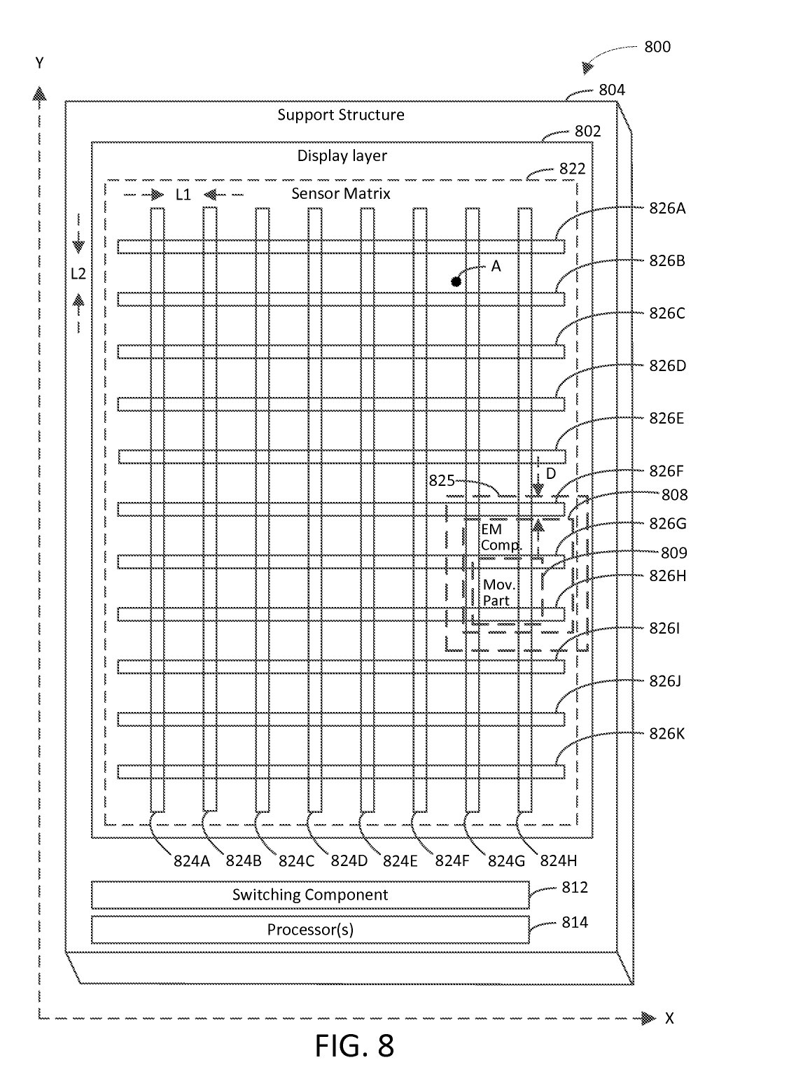

FIG. 8 is a block diagram of another example computing device 800 in accordance with an embodiment. Computing device 800 includes a display layer 802, a support structure 804, an electromechanical component 808 (labeled as “EM Comp.”), a movable part 809 (labeled “Mov. Part”), a switching component 812, and processor(s) 814, which are operable in a manner similar to the display layer 102, the support structure 104, the electromechanical component 108, the movable part 109, the switching component 112, and the processor(s) 114 shown in FIG. 1, though the display layer 822 is shown to include a sensor matrix 822. The sensor matrix 822 includes a plurality of column electrodes 824A-824H and a plurality of row electrodes 826A-826K (referred to collectively as a plurality of sensors). The plurality of column electrodes 824A-824H are arranged to be substantially parallel with a Y-axis, as shown in FIG. 8. The plurality of row electrodes 826A-826K are arranged to be substantially parallel with an X-axis. The plurality of column electrodes 824A-824H are arranged to be substantially perpendicular to the plurality of row electrodes 826A-826K. A first pitch, L1, between adjacent column electrodes 824A-824H indicates a distance between the midpoints of the adjacent column electrodes 824A-824H. A second pitch, L2, between adjacent row electrodes 826A-826K indicates a distance between the midpoints of the adjacent row electrodes 826A-826K. The first pitch, L1, and the second pitch, L2, may be any suitable values. The first pitch, L1, and the second pitch, L2, may be same or different. For instance, the first pitch, L1, and/or the second pitch, L2, may be approximately 2 mm, 3 mm, 4 mm, 5 mm, etc.

Placement of an object proximate a subset (e.g., one or more) of the column electrodes 824A-824H and a subset (e.g., one or more) of the row electrodes 826A-826K causes a change of capacitance to occur between the object and the electrodes in those subsets. For instance, such placement of the object may cause the capacitance to increase from a non-measurable quantity to a measurable quantity. The change of capacitance between the object and each electrode in the subsets may be used to generate a “capacitance map,” which may correlate to a shape of the object. For instance, a relatively greater capacitance change may indicate that a distance between the object and the corresponding electrode is relatively small. A relatively lesser capacitance change may indicate that a distance between the object and the corresponding electrode is relatively large. Accordingly, a capacitance map, which indicates capacitance changes associated with respective electrodes in the subsets, may indicate the shape of the object.

In an example embodiment, placement of an object proximate the sensor matrix 822 at point A causes a first capacitance between the object and row electrode 826A to change, a second capacitance between the object and row electrode 826B to change, a third capacitance between the object and column electrode 824F to change, and a fourth capacitance between the object and column electrode 824G to change. It will be recognized that capacitances between the object and other respective electrodes may change, as well. For instance, the capacitances between the object and those other respective electrodes may change so long as the object is within a designated proximity (3 mm, 5 mm, 7 mm, 10 mm, etc.) to those other electrodes. However, such changes would be less than the changes to the first, second, third, and fourth capacitances mentioned above due to the greater proximity of the object to those other electrodes. Accordingly, the discussion will focus on the first, second, third, and fourth capacitances mentioned above for ease of understanding.

Processor(s) 814 are configured to determine a location of an object that is placed proximate the sensor matrix 822 based on capacitance changes that are sensed by the plurality of column electrodes 824A-824H and the plurality of row electrodes 826A-826K or respective subsets thereof. Accordingly, in the example embodiment mentioned above, processor(s) 814 determine (e.g., estimate) the location, A, of the object based on the changes to the first, second, third, and fourth capacitances sensed at respective electrodes 826A, 826B, 824F, and 824G. For instance, processor(s) 814 may estimate (X,Y) coordinates of the location, A.

Determining the location, A, of the object with an accuracy on the order of the first pitch, L1, and/or the second pitch, L2, is relatively straightforward. For instance, a location of a column electrode at which a greatest capacitance change is sensed with respect to the object may indicate (e.g., provide an estimate of) an X coordinate of the location, A. A location of a row electrode at which a greatest capacitance change is sensed with respect to the object may indicate (e.g., provide an estimate of) a Y coordinate of the location, A.

One way to increase the accuracy of the estimate that is determined by processor(s) 814 is to decrease the first pitch, L1, between adjacent column electrodes 824A-824H and/or the second pitch, L2 between adjacent row electrodes 826A-826K. Another way to increase the accuracy is to interpolate (e.g., as a continuous function) the capacitance changes that are sensed by the plurality of column electrodes 824A-824H and the plurality of row electrodes 826A-826K or respective subsets thereof. For instance, in accordance with the example embodiment mentioned above, processor(s) 814 interpolate the changes to the first, second, third, and fourth capacitances to determine the location, A.

The switching component 812 is configured to switch the electromechanical component 808 from an “on” state to an “off” state in response to detection of an object within a specified proximity of a designated portion of the sensor matrix 822. For instance, the switching component 812 may switch the electromechanical component 808 from the “on” state to the “off” state in response to the object touching and/or hovering within the specified proximity of the designated portion of the sensor matrix 822. The designated proximity may correspond to a set distance, such as 1 mm, 2 mm, 3 mm, 3.5 mm, 5 mm, 7 mm, 10 mm, or 15 mm.

The designated portion of the sensor matrix 822 includes a subset of the plurality of sensors (i.e., a subset of the plurality of column electrodes 824A-824H and the plurality of row electrodes 826A-826K). For instance, the designated portion may include fewer than all, such as fewer than 5%, 10%, 15%, 20%, 25%, 30%, 35%, 40%, 45%, or 50%, of the sensors in the plurality of sensors. The subset corresponds to a location of the electromechanical component 808 with respect to the display layer 802. For example, the designated portion of the sensor matrix 822 may consist of a subset of the plurality of sensors that overlaps with a projection of the electromechanical component 808 onto the sensor matrix 822. In accordance with this example, the subset may consist of the column electrodes 824G and 824H and the row electrodes 826G and 826H as depicted in FIG. 8.

In another example, the designated portion of the sensor matrix 822 may consist of the subset of the plurality of sensors that overlaps with the projection of the electromechanical component 808 onto the sensor matrix 822 and a set number (1, 2, 3, 4, 5, etc.) of sensors in each direction beyond (i.e., outside of) a perimeter of the projection. For instance, the designated portion may consist of the subset that overlaps with the projection and the set number of concentric rings of sensors beyond the perimeter. In accordance with this example, if the set number is one, the designated portion may consist of the column electrodes 824F, 824G, and 824H and the row electrodes 826F, 826G, 826H, and 826I in FIG. 8.

In yet another example, the designated portion of the sensor matrix 822 may consist of the subset of the plurality of sensors that overlaps with the projection of the electromechanical component 808 onto the sensor matrix 822 and sensors that are within a specified distance, D, beyond (i.e., outside of) a perimeter of the projection. The boundary that extends the specified distance, D, beyond the perimeter of the projection defines an area 825. In accordance with this example, the designated portion may consist of the column electrodes 824G and 824H and the row electrodes 826F, 826G, and 826H as depicted in FIG. 8. It should be noted that the specified distance, D, shown in FIG. 8 is provided for illustrative purposes and is not intended to be limiting. It will be recognized that the specified distance, D, may be any suitable value. For instance, the specified distance, D, may be 10 mm, 12, mm, 15 mm, 20 mm, 25 mm, 30 mm, or 35 mm. Moreover, the designated portion of the sensor matrix 822 may include any suitable sensors of the plurality of sensors that correspond to the location of the electromechanical component 808 with respect to the display layer 802.

In still another example, the designated portion of the sensor matrix 822 may correspond to one of multiple portions of the sensor matrix 822 that are along an outer edge of the sensor matrix 822. For instance, the designated portion may consist of or include a subset of the plurality of sensors that overlaps an area on the display layer 802 that is within reach of an average human hand when the hand grasps an outer edge of the computing device 800 that overlaps with the subset of the plurality of sensors.

In an example embodiment, the switching component 812 is configured to, in response to the electromechanical component 808 being switched to the “off” state, switch the electromechanical component 808 from the “off” state to the “on” state when it is determined that the object is no longer within the specified proximity of the designated portion of the sensor matrix 822. For example, processor(s) 814 may determine that the object is no longer within the specified proximity of the designated portion of the sensor matrix 822 based on signals that are received from the plurality of sensors or a subset thereof. In accordance with this example, the processor(s) 814 may provide a control signal to the switching component 812 that causes the switching component 812 to switch the electromechanical component 808 from the “off” state to the “on” state in response to the determination that the object is no longer within the specified proximity of the designated portion of the sensor matrix 822.

In another example embodiment, the switching component 812 is configured to switch the electromechanical component 808 from the “on” state to the “off” state in response to a capacitance change that is detected by first sensor(s) in the subset of the plurality of sensors being greater than or equal to a capacitance change threshold. In an aspect of this embodiment, the first sensor(s) are configured to detect the capacitance change in accordance with a first detecting operation. In accordance with this aspect, the switching component 812 is configured to, in response to the electromechanical component 808 being switched from the “on” state to the “off” state, switch the electromechanical component 808 from the “off” state to the “on” state when it is determined that capacitance is less than or equal to a capacitance threshold. The capacitance is detected by second sensor(s) in the subset of the plurality of sensors in accordance with a second sensing operation that occurs after the first sensing operation. The capacitance threshold may correspond to a capacitance that is detected by one or more third sensors in the subset of the plurality of sensors when no objects are within the specified proximity of the designated portion of the sensor matrix, though the example embodiments are not limited in this respect. Any one or more of the first sensor(s), the second sensor(s), and/or the third sensor(s) may be the same sensor or different sensors.

In yet another example embodiment, the processor(s) 814 are configured to process signals that are received by the sensor matrix 822. In accordance with this embodiment, the processor(s) 814 are configured to distinguish between a plurality of pressure intensities. The plurality of pressure intensities corresponding to a plurality of respective potential intensities of a pressure (e.g., pressure 320 or 520) that the object applies against a portion of the display layer 802 that corresponds to the designated portion of the sensor matrix 822. The plurality of pressure intensities may include any suitable number of pressure intensities (e.g., 1024 or 2048). The plurality of pressure intensities may correspond to a plurality of respective potential capacitance changes (e.g., a plurality of potential capacitance changes per unit of time) between the object and the portion of the display layer 802 that corresponds to the designated portion of the sensor matrix 822.

In further accordance with this embodiment, the processor(s) 814 are configured to identify a first pressure intensity from the plurality of pressure intensities that is associated with one or more signals received by the designated portion of the sensor matrix 822 in response to the object being within the specified proximity of the designated portion of the sensor matrix 822. In further accordance with this embodiment, the switching component 812 is configured to switch the electromechanical component 808 from the “on” state to the “off” state further in response to the first pressure intensity being greater than or equal to a first intensity threshold.

In an aspect of this embodiment, a void (e.g., the void 106, 206, or 406) is defined between a first surface of the display layer 802 (e.g., the first surface 203 or 403 of the display layer 202 or 402) and a second surface of the support structure 804 (e.g., the second surface 205 or 405 of the support structure 204 or 404). In accordance with this aspect, the first surface and the second surface are on opposing sides of the void. In further accordance with this aspect, the processor(s) 814 are configured to determine that the first pressure intensity corresponds to an amount of deflection of the first surface 203 toward the second surface 205 that is greater than or equal to a deflection threshold. The deflection threshold corresponds to the first intensity threshold.

In another aspect of this embodiment, the processor(s) 814 are configured to identify the first pressure intensity in accordance with a first measurement operation. In accordance with this aspect, the processor(s) 814 are configured to identify a second pressure intensity from the plurality of pressure intensities that is associated with one or more second signals received by the designated portion of the sensor matrix 822 in accordance with a second measurement operation that occurs after the first measurement operation. In further accordance with this aspect, the switching component 812 is configured to, in response to the electromechanical component 808 being switched to the “off” state, switch the electromechanical component 808 from the “off” state to the “on” state when it is determined that the second pressure intensity is less than or equal to a second intensity threshold. The second intensity threshold may be less than or equal to the first intensity threshold.

It will be recognized that the computing device 800 shown in FIG. 8 may not include one or more of the display layer 802, the support structure 804, the electromechanical component 808, the movable part 809, the switching component 812, the processor(s) 814, the sensor matrix 822, the plurality of column electrodes 824A-824H, and/or the plurality of row electrodes 826A-826K. Furthermore, the computing device 800 may include components in addition to or in lieu of the display layer 802, the support structure 804, the electromechanical component 808, the movable part 809, the switching component 812, the processor(s) 814, the sensor matrix 822, the plurality of column electrodes 824A-824H, and/or the plurality of row electrodes 826A-826K.

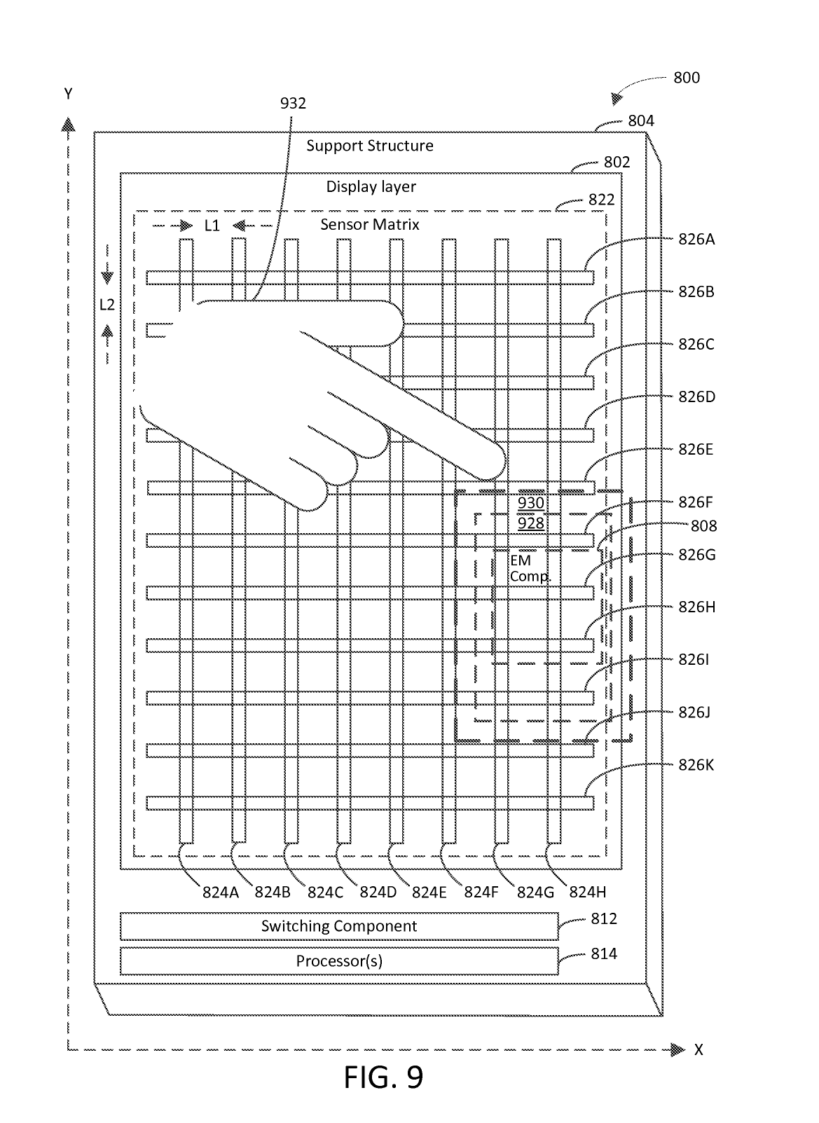

FIG. 9 is an illustration of the example computing device 800 of FIG. 8 in which an object 932 is shown to be not within a specified proximity 930 of a designated portion 928 of the sensor matrix 822 of the computing device 800 in accordance with an embodiment. Because the object 932 is not within the specified proximity 930 in the embodiment of FIG. 9, the processor(s) 814 may determine that the electromechanical component 808 is not to be switched from the “on” state to the “off” state as a result of the object 932 being placed over or on the display layer 802. Accordingly, the switching component 812 may maintain the electromechanical component 808 in the “on” state. The object 932 is represented as a hand in FIG. 9 for illustrative purposes and is not intended to be limiting. It will be recognized that the object 932 may be any suitable object, including but not limited to an electrostatic pen; a passive stylus; a finger; or other portion of a user's body (palm, wrist, forearm, or elbow), which the user may or may not intend to be detected.

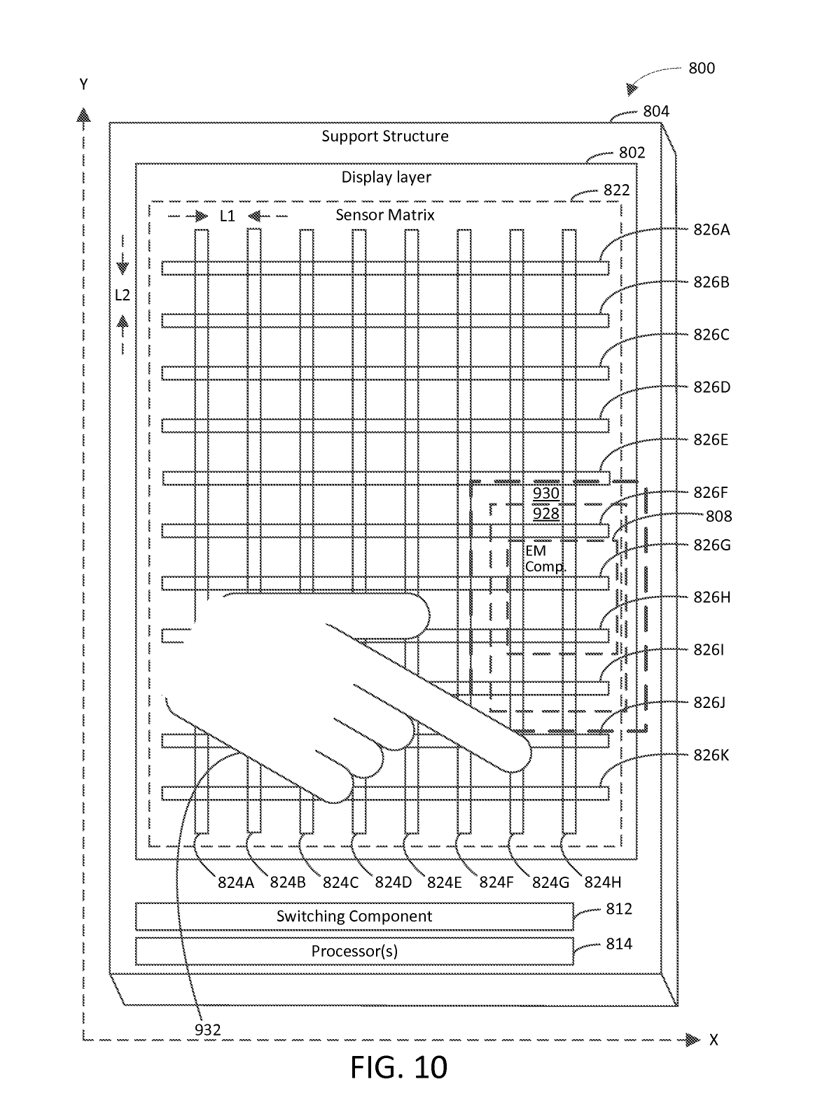

FIG. 10 is an illustration of the example computing device 800 of FIG. 8 in which an object 932 is shown to be within the specified proximity 930 of the designated portion 928 of the sensor matrix 822 of the computing device 800 in accordance with an embodiment. Because the object 932 is within the specified proximity 930 in the embodiment of FIG. 10, the processor(s) 814 may cause the switching component 812 to switch the electromechanical component 808 from the “on” state to the “off” state.

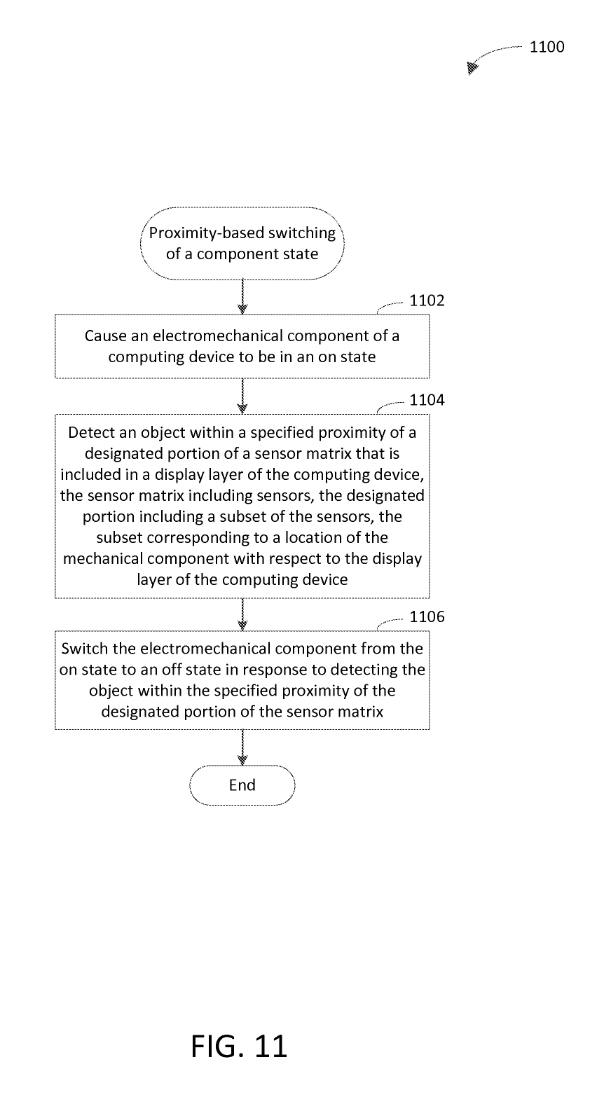

FIG. 11 depicts a flowchart 1100 of an example method for performing proximity-based switching of a component state in accordance with an embodiment. The flowchart 1100 may be performed by a computing device 100 shown in FIG. 1 or a computing device 800 shown in FIGS. 8-10, for example. For illustrative purposes, the flowchart 1100 is described with respect to the computing device 800 shown in FIGS. 8-10. Further structural and operational embodiments will be apparent to persons skilled in the relevant art(s) based on the discussion regarding the flowchart 1100.

As shown in FIG. 11, the method of the flowchart 1100 begins at step 1102. In step 1102, an electromechanical component of a computing device is caused to be in an “on” state. For instance, step 1102 may include applying an activation signal to the electromechanical component. Application of the activation signal may cause a moving part of the electromechanical component to move. In an example implementation, a switching component 812 of the computing device 800 causes an electromechanical component 808 to be in the “on” state.

At step 1104, an object within a specified proximity of a designated portion of a sensor matrix that is included in a display layer of the computing device is detected. The sensor matrix includes sensors. The designated portion includes a subset of the sensors. The subset corresponds to a location of the mechanical component with respect to the display layer of the computing device. In an example implementation, a subset of sensors in a sensor matrix 822, which is included in a display layer 802 of the computing device 800, detects an object 932 within a specified proximity 930 of a designated portion 928 of the sensor matrix 822 that includes the subset.

At step 1106, the electromechanical component is switched from the “on” state to an “off” state in response to detecting the object within the specified proximity of the designated portion of the sensor matrix. For instance, step 1106 may include discontinuing the application of the activation signal to the electromechanical component 808. In an example implementation, the switching component 812 switches the electromechanical component 808 from the “on” state to the “off” state in response to detecting the object 932 within the specified proximity 930 of the designated portion 928 of the sensor matrix 822.

In some example embodiments, one or more steps 1102, 1104, and/or 1106 of flowchart 1100 may not be performed. Moreover, steps in addition to or in lieu of steps 1102, 1104, and/or 1106 may be performed.

### III. Further Discussion of Some Example Embodiments

A first example computing device includes a display layer, a support structure, a deflection sensor, an electromechanical component, and a switching component. The support structure forms a void between the display layer and the support structure. The void is defined between a first surface of the display layer and a second surface of the support structure on opposing sides of the void. The deflection sensor is configured to determine an amount of deflection of the first surface toward the second surface in response to a pressure that is applied to a third surface of the display layer. The first surface and the third surface are on opposing sides of the display layer. The electromechanical component comprises a movable part that is configured to move in response to an activation signal being applied to the electromechanical component. The electromechanical component is configured to be in an on state or an off state. The on state is characterized by the activation signal being applied to the electromechanical component. The off state is characterized by the activation signal not being applied to the electromechanical component. The switching component is configured to switch the electromechanical component from the on state to the off state in response to the deflection reaching a deactivation threshold.

In a first aspect of the first example computing device, the switching component is configured to switch the electromechanical component to the off state for a specified period of time in response to the deflection reaching the deactivation threshold.

In a second aspect of the first example computing device, the switching component is configured to switch the electromechanical component from the off state to the on state in response to the deflection reaching a reactivation threshold. The second aspect of the first example computing device may be implemented in combination with the first aspect of the first example computing device, though the example embodiments are not limited in this respect.

In a third aspect of the first example computing device, the deactivation threshold is equal to approximately one half of the distance between the first surface and the second surface in absence of pressure being applied to the third surface of the display layer. The third aspect of the first example computing device may be implemented in combination with the first and/or second aspect of the first example computing device, though the example embodiments are not limited in this respect.

In a fourth aspect of the first example computing device, the deflection sensor comprises a strain sensor configured to sense a strain that is imposed on the display layer based on the pressure being applied to the third surface. In accordance with the fourth aspect, the deflection sensor is configured to determine the amount of the deflection based on the strain. The fourth aspect of the first example computing device may be implemented in combination with the first, second, and/or third aspect of the first example computing device, though the example embodiments are not limited in this respect.

In a fifth aspect of the first example computing device, the deflection sensor is coupled to the display layer. In accordance with the fourth aspect, the electromechanical component is coupled to the support structure. The fifth aspect of the first example computing device may be implemented in combination with the first, second, third, and/or fourth aspect of the first example computing device, though the example embodiments are not limited in this respect.

In a sixth aspect of the first example computing device, the deflection sensor is coupled to the support structure. In accordance with the sixth aspect, the electromechanical component is coupled to the display layer. The sixth aspect of the first example computing device may be implemented in combination with the first, second, third, and/or fourth aspect of the first example computing device, though the example embodiments are not limited in this respect.

A second example computing device includes a display layer, a support structure, a deflection sensor, an electromechanical component, and a switching component. The support structure forms a void between the display layer and the support structure. The void is defined between a first surface of the display layer and a second surface of the support structure on opposing sides of the void. The deflection sensor is configured to determine an amount of deflection of the second surface toward the first surface in response to a pressure that is applied to a third surface of the support structure. The second surface and the third surface are on opposing sides of the support structure. The electromechanical component comprises a movable part that is configured to move in response to an activation signal being applied to the electromechanical component. The electromechanical component is configured to be in an on state or an off state. The on state is characterized by the activation signal being applied to the electromechanical component. The off state is characterized by the activation signal not being applied to the electromechanical component. The switching component is configured to switch the electromechanical component from the on state to the off state in response to the deflection reaching a deactivation threshold.

In a first aspect of the second example computing device, the switching component is configured to switch the electromechanical component to the off state for a specified period of time in response to the deflection reaching the deactivation threshold.

In a second aspect of the second example computing device, the switching component is configured to switch the electromechanical component from the off state to the on state in response to the deflection reaching a reactivation threshold. The second aspect of the second example computing device may be implemented in combination with the first aspect of the second example computing device, though the example embodiments are not limited in this respect.

In a third aspect of the second example computing device, the deactivation threshold is equal to approximately one half of a distance between the first surface and the second surface in absence of the pressure being applied to the third surface of the support structure. The third aspect of the second example computing device may be implemented in combination with the first and/or second aspect of the second example computing device, though the example embodiments are not limited in this respect.

In a fourth aspect of the second example computing device, the deflection sensor comprises a strain sensor configured to sense a strain that is imposed on the support structure based on the pressure being applied to the third surface. In accordance with the fourth aspect, the deflection sensor is configured to determine the amount of the deflection based on the strain. The fourth aspect of the second example computing device may be implemented in combination with the first, second, and/or third aspect of the second example computing device, though the example embodiments are not limited in this respect.

In a fifth aspect of the second example computing device, the deflection sensor is coupled to the display layer. In accordance with the fifth aspect, the electromechanical component is coupled to the support structure. The fifth aspect of the second example computing device may be implemented in combination with the first, second, third, and/or fourth aspect of the second example computing device, though the example embodiments are not limited in this respect.

In a sixth aspect of the second example computing device, the deflection sensor is coupled to the support structure. In accordance with the sixth aspect, the electromechanical component is coupled to the display layer. The sixth aspect of the second example computing device may be implemented in combination with the first, second, third, and/or fourth aspect of the second example computing device, though the example embodiments are not limited in this respect.

A third example computing device includes a display layer, a support structure, an electromechanical component, and a switching component. The display layer comprises a sensor matrix. The sensor matrix includes a plurality of sensors. The support structure is configured to form a void between the display layer and the support structure. The electromechanical component comprises a movable part that is configured to move in response to an activation signal being applied to the electromechanical component. The electromechanical component is configured to be in an on state or an off state. The on state is characterized by the activation signal being applied to the electromechanical component. The off state is characterized by the activation signal not being applied to the electromechanical component. The switching component is configured to switch the electromechanical component from the on state to the off state in response to detection of an object within a specified proximity of a designated portion of the sensor matrix. The designated portion includes a subset of the plurality of sensors. The subset corresponds to a location of the electromechanical component with respect to the display layer.

In a first aspect of the third example computing device, the switching component is configured to switch the electromechanical component from the off state to the on state in response to a determination that the object is no longer within the specified proximity of the designated portion of the sensor matrix.

In a second aspect of the third example computing device, the third example computing device further comprises at least one processor configured to process signals that are received by the sensor matrix. In accordance with the second aspect, the at least one processor is configured to distinguish between a plurality of pressure intensities. The plurality of pressure intensities corresponds to a plurality of respective potential intensities of pressure that the object applies against a portion of the display that corresponds to the designated portion of the sensor matrix. In further accordance with the second aspect, the at least one processor is configured to identify a first pressure intensity that is associated with one or more signals received by the designated portion of the sensor matrix in response to the object being within the specified proximity of the designated portion of the sensor matrix. In further accordance with the second aspect, the switching component is configured to switch the electromechanical component from the on state to the off state in response to the first pressure intensity being greater than or equal to an intensity threshold.

In one example implementation of the second aspect, the void is defined between a first surface of the display layer and a second surface of the support structure on opposing sides of the void. In accordance with this example implementation, the at least one processor is configured to determine that the first pressure intensity corresponds to an amount of deflection of the first surface toward the second surface that is greater than or equal to a deflection threshold, the deflection threshold corresponding to the intensity threshold.

In another example implementation of the second aspect, the at least one processor is configured to identify the first pressure intensity in accordance with a first measurement operation. In accordance with this example implementation, the at least one processor is configured to identify a second pressure intensity that is associated with one or more second signals received by the designated portion of the sensor matrix in accordance with a second measurement operation that occurs after the first measurement operation. In further accordance with this example implementation, the switching component is configured to switch the electromechanical component from the off state to the on state in response to the second pressure intensity being less than or equal to a second intensity threshold.

The second aspect of the third example computing device may be implemented in combination with the first aspect of the third example computing device, though the example embodiments are not limited in this respect.

In a third aspect of the third example computing device, the switching component is configured to switch the electromechanical component from the on state to the off state in response to a capacitance change that is detected by at least one sensor in the subset of the plurality of sensors being greater than or equal to a capacitance change threshold. In an example implementation of the third aspect, the at least one sensor is configured to detect the capacitance change in accordance with a first detecting operation. In accordance with this example implementation, the switching component is configured to switch the electromechanical component from the off state to the on state in response to a capacitance, which is detected by at least one sensor in the subset of the plurality of sensors in accordance with a second sensing operation that occurs after the first sensing operation, being less than or equal to a capacitance threshold. The third aspect of the third example computing device may be implemented in combination with the first and/or second aspect of the third example computing device, though the example embodiments are not limited in this respect.

In a fourth aspect of the third example computing device, the designated portion of the sensor matrix corresponds to one of a plurality of portions of the sensor matrix that are along an outer edge of the sensor matrix. The fourth aspect of the third example computing device may be implemented in combination with the first, second, and/or third aspect of the third example computing device, though the example embodiments are not limited in this respect.

### IV. Example Computer System

FIG. 12 depicts an example computer 1200 in which embodiments may be implemented. Any one or more of computing device 100 shown in FIG. 1, computing device 200 shown in FIGS. 2-3, computing device 400 shown in FIGS. 4-5, and/or computing device 800 shown in FIGS. 8-10 may be implemented using computer 1200, including one or more features of computer 1200 and/or alternative features. Computer 1200 may be a general-purpose computing device in the form of a conventional personal computer, a mobile computer, or a workstation, for example, or computer 1200 may be a special purpose computing device. The description of computer 1200 provided herein is provided for purposes of illustration, and is not intended to be limiting. Embodiments may be implemented in further types of computer systems, as would be known to persons skilled in the relevant art(s).

As shown in FIG. 12, computer 1200 includes a processing unit 1202, a system memory 1204, and a bus 1206 that couples various system components including system memory 1204 to processing unit 1202. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computer 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROMs), and the like.

A number of program modules may be stored on the hard disk, magnetic disk, optical disk, ROM, or RAM. These programs include an operating system 1230, one or more application programs 1232, other program modules 1234, and program data 1236. Application programs 1232 or program modules 1234 may include, for example, computer program logic for implementing any one or more components (or portions thereof) of a computing device 100, 200, 400, or 800, flowchart 600 or any step(s) thereof, flowchart 700 or any step(s) thereof, and/or flowchart 1100 or any step(s) thereof, as described herein.

A user may enter commands and information into the computer 1200 through input devices such as keyboard 1238 and pointing device 1240. Other input devices (not shown) may include a microphone, joystick, game pad, satellite dish, scanner, touch screen, camera, accelerometer, gyroscope, or the like. These and other input devices are often connected to the processing unit 1202 through a serial port interface 1242 that is coupled to bus 1206, but may be connected by other interfaces, such as a parallel port, game port, or a universal serial bus (USB).

A display device 1244 (e.g., a monitor) is also connected to bus 1206 via an interface, such as a video adapter 1246. For instance, the display device 1244 may include display layer 102, 202, 402, or 802; support structure 104, 204, 404, or 804; electromechanical component 108, 208, 408, or 808, etc. In addition to display device 1244, computer 1200 may include other peripheral output devices (not shown) such as speakers and printers.

Computer 1200 is connected to a network 1248 (e.g., the Internet) through a network interface or adapter 1250, a modem 1252, or other means for establishing communications over the network. Modem 1252, which may be internal or external, is connected to bus 1206 via serial port interface 1242.

As used herein, the terms “computer program medium” and “computer-readable storage medium” are used to generally refer to media (e.g., non-transitory media) such as the hard disk associated with hard disk drive 1214, removable magnetic disk 1218, removable optical disk 1222, as well as other media such as flash memory cards, digital video disks, random access memories (RAMs), read only memories (ROM), and the like. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 1232 and other program modules 1234) may be stored on the hard disk, magnetic disk, optical disk, ROM, or RAM. Such computer programs may also be received via network interface 1250 or serial port interface 1242. Such computer programs, when executed or loaded by an application, enable computer 1200 to implement features of embodiments discussed herein. Accordingly, such computer programs represent controllers of the computer 1200.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### V. Conclusion

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A computing device comprising:
a display layer;
a support structure that forms a void between the display layer and the support structure, the void defined between a first surface of the display layer and a second surface of the support structure on opposing sides of the void;
a deflection sensor configured to determine an amount of deflection of the first surface toward the second surface in response to a pressure that is applied to a third surface of the display layer, the first surface and the third surface being on opposing sides of the display layer;
an electromechanical component comprising a movable part that is configured to move in response to an activation signal being applied to the electromechanical component, the electromechanical component configured to be in an on state or an off state, the on state characterized by the activation signal being applied to the electromechanical component, the off state characterized by the activation signal not being applied to the electromechanical component; and
a switching component configured to switch the electromechanical component from the on state to the off state in response to the deflection reaching a deactivation threshold.

2. The computing device of claim 1, wherein the switching component is configured to switch the electromechanical component to the off state for a specified period of time in response to the deflection reaching the deactivation threshold.

3. The computing device of claim 1, wherein the switching component is configured to switch the electromechanical component from the off state to the on state in response to the deflection reaching a reactivation threshold.

4. The computing device of claim 1, wherein the deactivation threshold is equal to approximately one half of the distance between the first surface and the second surface in absence of pressure being applied to the third surface of the display layer.

5. The computing device of claim 1, wherein the deflection sensor is coupled to the display layer; and
wherein the electromechanical component is coupled to the support structure.

6. The computing device of claim 1, wherein the deflection sensor is coupled to the support structure; and
wherein the electromechanical component is coupled to the display layer.

7. The computing device of claim 1, wherein the deflection sensor comprises:
a strain sensor configured to sense a strain that is imposed on the display layer based on the pressure being applied to the third surface, wherein the deflection sensor is configured to determine the amount of the deflection based on the strain.

8. A computing device comprising:
a display layer;
a support structure that forms a void between the display layer and the support structure, the void defined between a first surface of the display layer and a second surface of the support structure on opposing sides of the void;
a deflection sensor configured to determine an amount of deflection of the second surface toward the first surface in response to a pressure that is applied to a third surface of the support structure, the second surface and the third surface being on opposing sides of the support structure;
an electromechanical component comprising a movable part that is configured to move in response to an activation signal being applied to the electromechanical component, the electromechanical component configured to be in an on state or an off state, the on state characterized by the activation signal being applied to the electromechanical component, the off state characterized by the activation signal not being applied to the electromechanical component; and
a switching component configured to switch the electromechanical component from the on state to the off state in response to the deflection reaching a deactivation threshold.

9. The computing device of claim 8, wherein the switching component is configured to switch the electromechanical component to the off state for a specified period of time in response to the deflection reaching the deactivation threshold.

10. The computing device of claim 8, wherein the switching component is configured to switch the electromechanical component from the off state to the on state in response to the deflection reaching a reactivation threshold.

11. The computing device of claim 8, wherein the deflection sensor is coupled to the support structure; and
wherein the electromechanical component is coupled to the display layer.

12. The computing device of claim 8, wherein the deflection sensor comprises:
a strain sensor configured to sense a strain that is imposed on the support structure based on the pressure being applied to the third surface; and
wherein the deflection sensor is configured to determine the amount of the deflection based on the strain.

13. A computing device comprising:
a display layer comprising a sensor matrix, the sensor matrix including a plurality of sensors;
a support structure configured to form a void between the display layer and the support structure;
an electromechanical component comprising a movable part that is configured to move in response to an activation signal being applied to the electromechanical component, the electromechanical component configured to be in an on state or an off state, the on state characterized by the activation signal being applied to the electromechanical component, the off state characterized by the activation signal not being applied to the electromechanical component; and
a switching component configured to switch the electromechanical component from the on state to the off state in response to detection of an object within a specified proximity of a designated portion of the sensor matrix, the designated portion including a subset of the plurality of sensors, the subset corresponding to a location of the electromechanical component with respect to the display layer.

14. The computing device of claim 13, wherein the switching component is configured to switch the electromechanical component from the off state to the on state in response to a determination that the object is no longer within the specified proximity of the designated portion of the sensor matrix.

15. The computing device of claim 13, further comprising:
at least one processor configured to process signals that are received by the sensor matrix;
wherein the at least one processor is configured to distinguish between a plurality of pressure intensities, the plurality of pressure intensities corresponding to a plurality of respective potential intensities of pressure that the object applies against a portion of the display that corresponds to the designated portion of the sensor matrix;
wherein the at least one processor is configured to identify a first pressure intensity that is associated with one or more signals received by the designated portion of the sensor matrix in response to the object being within the specified proximity of the designated portion of the sensor matrix; and
wherein the switching component is configured to switch the electromechanical component from the on state to the off state in response to the first pressure intensity being greater than or equal to an intensity threshold.

16. The computing device of claim 15, wherein the void is defined between a first surface of the display layer and a second surface of the support structure on opposing sides of the void; and
wherein the at least one processor is configured to determine that the first pressure intensity corresponds to an amount of deflection of the first surface toward the second surface that is greater than or equal to a deflection threshold, the deflection threshold corresponding to the intensity threshold.

17. The computing device of claim 15, wherein the at least one processor is configured to identify the first pressure intensity in accordance with a first measurement operation;
wherein the at least one processor is configured to identify a second pressure intensity that is associated with one or more second signals received by the designated portion of the sensor matrix in accordance with a second measurement operation that occurs after the first measurement operation; and
wherein the switching component is configured to switch the electromechanical component from the off state to the on state in response to the second pressure intensity being less than or equal to a second intensity threshold.

18. The computing device of claim 13, wherein the switching component is configured to switch the electromechanical component from the on state to the off state in response to a capacitance change that is detected by at least one sensor in the subset of the plurality of sensors being greater than or equal to a capacitance change threshold.

19. The computing device of claim 18, wherein the at least one sensor is configured to detect the capacitance change in accordance with a first detecting operation; and
wherein the switching component is configured to switch the electromechanical component from the off state to the on state in response to a capacitance, which is detected by at least one sensor in the subset of the plurality of sensors in accordance with a second sensing operation that occurs after the first sensing operation, being less than or equal to a capacitance threshold.

20. The computing device of claim 13, wherein the designated portion of the sensor matrix corresponds to one of a plurality of portions of the sensor matrix that are along an outer edge of the sensor matrix.
